(19) United States
(12) Patent Application Publication
(10) Pub. No.: US 2008/0064423 A1
(43) Pub. Date: Mar. 13, 2008

(54) Wireless communication apparatus with message transformation function

(75) Inventors: Yu-Lin Tsai, Taipei (TW); Yung-Lang Huang, Taipei (TW); Tian-Sen Wu, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/725,503

(22) Filed: Mar. 20, 2007

(30) Foreign Application Priority Data
Sep. 12, 2006 (TW) 095133732

(51) Int. Cl. H04Q 7/20

(52) U.S. Cl. 455/466

(57) ABSTRACT

A wireless communication apparatus includes a voice-receiving module, a voice-text transforming module and a wireless communicating module. The voice-receiving module receives voice information. The voice-text transforming module transforms the voice information to corresponding text information. The wireless communicating module transforms the text information to at least one data packet and transmits the data package at a preset time.

### BACKGROUND OF THE INVENTION

1. Field of Invention

The invention relates to a wireless communication apparatus and, more particularly, to a wireless communication apparatus with a voice-text transforming function.

2. Description of the Related Art

With the development of science, an electrical device changes a lot. For example, communication devices have been developed from wired communication apparatus to wireless communication apparatus. Referring to FIG. 1, a conventional wireless communication apparatus includes an antenna 11, a display 12, and keys 13. The antenna 11 is used for transmitting and receiving electromagnetic waves to communicate with other wireless communication apparatus. The display 12 is used for displaying information. The keys 13 are provided for users to input information and control the wireless communication apparatus 1.

Generally speaking, there are two ways for users to communicate with others via the wireless communication apparatus 1. One way is to make a phone call, by which the users communicate directly by voice, and the other way is to send a short message. Usually users communicate with others directly by making phone calls. However, when the phone services is not available, or when direct voice communication is not suitable, sending short message is needed to transmit information. When this happens, users input text information by pressing keys 13. Due to inconvenient input methods or incorrect operations, users may suffer from spending a lot time to input text information. Furthermore, since generally users cannot set a time to send a short message, they cannot choose when to send the short message freely.

Therefore, how provide a wireless communication apparatus that allows users to input information easily in various ways and set the sending time of short messages to improve the operation efficiencies of both the users and the communication apparatus has become an urgent issue in this field.

### BRIEF SUMMARY OF INVENTION

An objective of the invention is to provide a wireless communication apparatus which allows users to input text information conveniently when sending a text message to improve the operation efficiencies of both the users and the communication apparatus.

To achieve the above objectives, the wireless communication apparatus according to the invention includes a voice-receiving module, a voice-text transforming module, and a wireless communicating module. The voice-receiving module receives voice information. The voice-text transforming module transforms the voice information to corresponding text information. The wireless communicating module transforms the text information into at least one data packet and then transmits the data package at a preset time.

The voice information may include preset time information, and the voice-text module may read the preset time information and sets a sending time of the short message.

The invention also discloses another wireless communication apparatus which includes a wireless communicating module and a voice-text transforming module. The wireless communicating module receives a data packet, and transforms the data packet into text information. The voice-text transforming module transforms the text information to corresponding voice information.

As mentioned above, the wireless communication apparatus of the present invention includes a voice-text transforming module. When users want to send short messages, they only need to speak out what they want to send, and the voice-text transforming module transforms the voice information received from the voice-receiving module to the corresponding text information. The wireless communicating module transforms the text information to the data packet and sends it at a preset time. Comparing with the conventional technology, the text information is input by voice instead of by pressing keys. Therefore, the operation efficiencies of both the users and the wireless communication apparatus can be improved. In addition, when the wireless communication apparatus receives a short message, the voice-text transforming module may transform the text information to voice information, and may play it via the voice-playing module.

### BRIEF DESCRIPTION OF THE DRAWINGS

FIG. 1 is a schematic diagram showing of a current wireless communication apparatus.

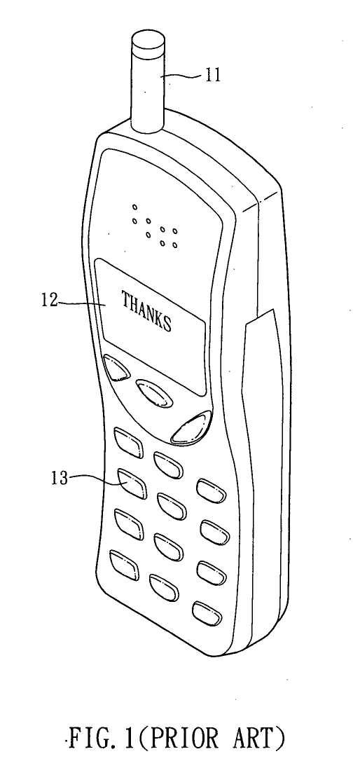

FIG. 2 is a block diagram showing the wireless communication apparatus according to an embodiment of the invention.

### DETAILED DESCRIPTION OF THE EMBODIMENT

These and other features, aspects, and advantages of the present invention will become better understood with regard to the following description, appended claims, and accompanying drawings.

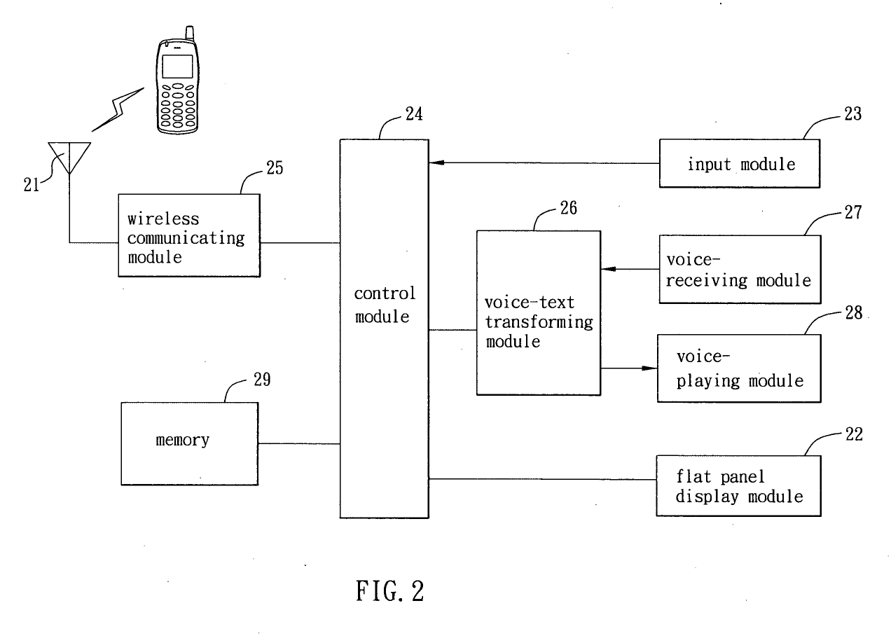

Referring to FIG. 2, a wireless communication apparatus 2 according to an embodiment of the invention includes an antenna 21, a flat panel display module 22, and an input module 23. The antenna 21 transfers and receives information via electromagnetic waves when communicating with other wireless communication apparatus. Therefore, as long as the antenna 21 can operate under the way the wireless communication apparatus 2 communicates, the type and style of the antenna 21 is not limited. The way the wireless communication apparatus 2 communicates can be based on Global System for Mobile Communication (GSM), General Packet Radio Service (GPRS), Wireless Fidelity (Wi-Fi), and so on. In addition, the wireless communication apparatus 2 can be a GSM phone, a Personal Digital Assistant (PDA) phone, or a smart phone.

In the embodiment, the flat panel display module 22 can be a Liquid Crystal Display (LCD) module, a Light-Emitting Diode (LED) display module, or an Organic Electro Luminescent Device (OELD).

In the embodiment, the input module 23 includes keys (not shown in the figure). Users can input information and control the wireless communication apparatus 2 by pressing the keys. Of course, the input module 23 may include a touch panel to perform the same function as the keys.

The wireless communication apparatus 2 further includes a control module 24 and a wireless communicating module 25. The input module 23, the flat panel display module 22, and the wireless communicating module 25 are electrically connected to the control module 24. The antenna 21 is electrically connected to the wireless communicating module 25.

In the embodiment, the control module 24 includes a Micro Controller Unit (MCU) or a Central Processing Unit (CPU). The wireless communicating module 25 may include a Base Band circuit and a Radio Frequency circuit to handle packet processing, carrier wave composition, and signal transferring/receiving. These technologies are well-known; therefore relevant descriptions are omitted here for concise purpose.

In the embodiment, the wireless communication apparatus 2 further includes a voice-text transforming module 26 electrically connected to the control module 24. The voice-text transforming module 26 can have the audio convert to text information function, the text convert to voice information function, or both. In the embodiment, the voice information includes preset-time information. The voice-text transforming module reads the preset-time information and retrieves the sending time of the short message. In the embodiment, the voice-text transforming module 26 may include voice recognition unit or voice-text transformation program.

The wireless communication apparatus 2 further includes a voice-receiving module 27 and a voice-playing module 28 which are electrically connected to the voice-text transforming module 26. The voice-receiving module 27 can be a microphone, and the voice-playing module can be a speaker or an earphone.

In the embodiment, when users want to send short messages, they speak what they want to send to the voice-receiving module 27, and the voice-receiving 27 receives voice information and transmits it to the voice-text transforming module 26. The voice-text transforming module 26 transforms the voice information into corresponding text information, and the control module 24 controls the wireless communicating module 25 to convert the text information to a data packet and transmit the data packet. Afterwards, a transmission of the short message is finished.

In the embodiment, users may input the voice information first, and send it at a preset time. The control module 24 stores the voice information in a memory 29 of the wireless communication apparatus 2, and then transforms the voice information into text information and sends it via packet at the preset time. The wireless communication apparatus 2 also can transform the voice information to corresponding text information and store it first, and then send the data packet at the preset time later.

Furthermore, when other wireless communication apparatus want to send short messages to the wireless communication apparatus 2, the wireless communicating module 25 receives the data packet from the other wireless communication apparatus and converts it to corresponding text information. The text information is stored in the memory 29, and the control module 24 sends an alert signal which may be displayed on the flat panel display module 22 to remind users that a new message is coming. When the users want listen to the message, the voice-text transforming module 26 transforms the text information to the corresponding voice information, and the voice-playing module 28 plays the voice information. Therefore, the users listen to the short message directly instead of read it word by word.

According to the wireless communication apparatus of the embodiment of the invention, when users want to send short messages, they only need to speak out what they want to send, and the voice-text transforming module transforms voice information received from the voice-receiving module into corresponding text information, and the wireless communicating module converts the text information to a data packet and send it at a preset time.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A wireless communication apparatus, comprising:
a voice-receiving module for receiving voice information;
a voice-text transforming module for transforming the voice information to corresponding text information; and
a wireless communicating module for transforming the text information to a data packet and sending the data packet in a preset time.

2. The wireless communication apparatus according to claim 1, wherein the voice-text transforming module includes a voice recognition unit.

3. The wireless communication apparatus according to claim 1, wherein the wireless communicating module receives another data packet and transforms the other data packet to another text information, and the voice-text transforming module transforms the other text information to another voice information.

4. The wireless communication apparatus according to claim 3, further comprising a voice-playing module for playing the other voice information.

5. The wireless communication apparatus according to claim 4, wherein the voice-playing module is a speaker.

6. The wireless communication apparatus according to claim 1, wherein the voice-text transforming module includes a voice-text transforming program.

7. The wireless communication apparatus according to claim 1, wherein the voice-receiving module is a microphone.

8. A wireless communication apparatus, comprising:
a wireless communicating module for receiving a data packet and transforming the data packet to text information; and
a voice-text transforming module for transforming the text information to corresponding voice information.

9. The wireless communication apparatus according to claim 8, wherein the voice-text transforming module includes a voice-text transforming program.

10. The wireless communication apparatus according to claim 8, further comprising a voice-playing module for playing the voice information.

11. The wireless communication apparatus according to claim 10, wherein the voice-playing module is a speaker.
